(19) United States
(12) Patent Application Publication
(10) Pub. No.: US 2008/0177602 A1
(43) Pub. Date: Jul. 24, 2008

(54) METHOD AND APPARATUS FOR DELIVERING PRESENTATIONS

(76) Inventors: Bradley A. SOPHER, Baltimore, MD (US); Jordan A. Sopher, Baltimore, MD (US); Michael A. Sopher, Owings Mills, MD (US); Steven F. Sopher, Baltimore, MD (US)

Correspondence Address: DLA PIPER US LLP, P. O. BOX 9271, RESTON, VA, 20195, US

(21) Appl. No.: 12/015,204

(22) Filed: Jan. 16, 2008

Related U.S. Application Data
(60) Provisional application No. 60/885,328, filed on Jan. 17, 2007.

(51) Int. Cl. G06Q 30/00; G06F 3/048

(52) U.S. Cl. 705/7; 715/734; 705/14

(57) ABSTRACT

A method and system are disclosed that connects an end user, a specialist and a host website, via a network, so that the end user can view at least one presentation. The specialist provides information relating to the end user to the host website. The host website produces a product such as a CD, URL, and/or recordable medium that contains an ID based on the information. Such an ID can be associated with at least one presentation. In response to the ID in the product, the end user can access the host website, via the network, to view the at least one presentation.

This application is based on and derives priority from pending U.S. patent application Ser. No. 60/885,328, filed Jan. 17, 2007. The entire content of this application is herein incorporated by reference in its entirety.

The present invention relates to a method and system of providing information using a web-based database for consumer education and/or marketing.

### BRIEF DESCRIPTION OF THE DRAWINGS

Reference is made to the attached drawings, wherein elements having the same reference designations represent like elements throughout and wherein:

FIG. 1 illustrates the value of a delivery system for both the specialist and the VAR for the purpose of reaching the end user.

FIG. 2 illustrates an embodiment of a communication system for delivering information for an end user's education and/or for marketing purposes by the specialist.

FIG. 3 illustrates in flow-chart form the method employed by a host website client such as a specialist in creating an account, managing the account, and/or ordering information.

FIG. 4 illustrates in flow-chart form the process by which an end user interacts with the CD or URL given by the specialist via an internet platform with education and treatment information.

FIG. 5 illustrates an exemplary interface for the specialist to customize their account.

FIG. 6 illustrates an exemplary interface for the specialist to send an e-mail via the Internet relating to educational and marketing recommendations via the internet.

FIG. 7 illustrates an exemplary interface for the end user displaying the specialist's educational and marketing recommendations.

FIG. 8 illustrates an exemplary splash screen interface that may greet an end user prior to viewing to a presentation.

FIG. 9 illustrates a exemplary screen-shot interface of a main menu that may be displayed to the end user.

FIG. 10 illustrates an exemplary screen-shot interface of a submenu.

FIG. 11 illustrates an exemplary interface of educational and marketing information that may be displayed to the end user.

FIG. 12 illustrates an exemplary interface that provides a end user with the specialist's marketing recommendations.

FIG. 13 illustrates an exemplary screen-shot of information notifying the end user of additional recommended presentations.

FIG. 14 illustrates an exemplary interface that provides an end user with information about their specialist.

FIG. 15 illustrates in flow-chart form a vendor interaction and experience with the host website, specialist and a end user.

FIG. 16 illustrates in flow-chart form the host website's administration of the presentation software.

### DETAILED DESCRIPTION OF SEVERAL EMBODIMENTS

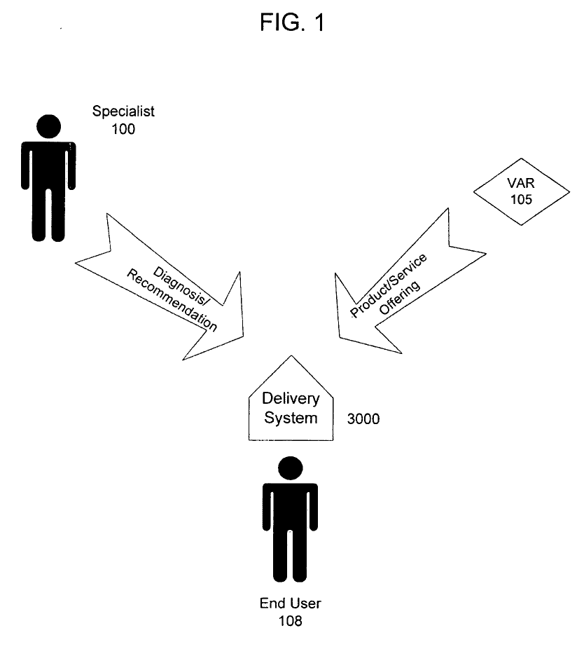

FIG. 1 illustrates a communication system in which a specialist 100 and/or vendor 105 can provide information to end user 108 for educational and marketing purposes. The vendor 105 can leverage the information a specialist 100 desires an end user to have to more effectively reach the end user 108. Similarly, the specialist 100 can leverage the offering of a vendor 105 to capitalize on increased sales. The delivery system 3000 provides a platform for the specialist 100 and vendor 105 to capture the end user 108 at a point of interest for purposes such as purchase of a product or service. Although not limited to these fields and industries, such a delivery system 3000 can be used in the medical, pharmaceutical, nutritional, physical fitness, automotive, agricultural, home improvement, cosmetology/fashion, culinary, educational institutions, and/or ecology related areas. Specialist 100 is a person, persons, or an entity that holds knowledge in a particular field. Thus, for example, the field can be medical, specialist 100 can be a physician, end user 108 can be a patient, and vendor 105 can market products associated with the practice of the physician.

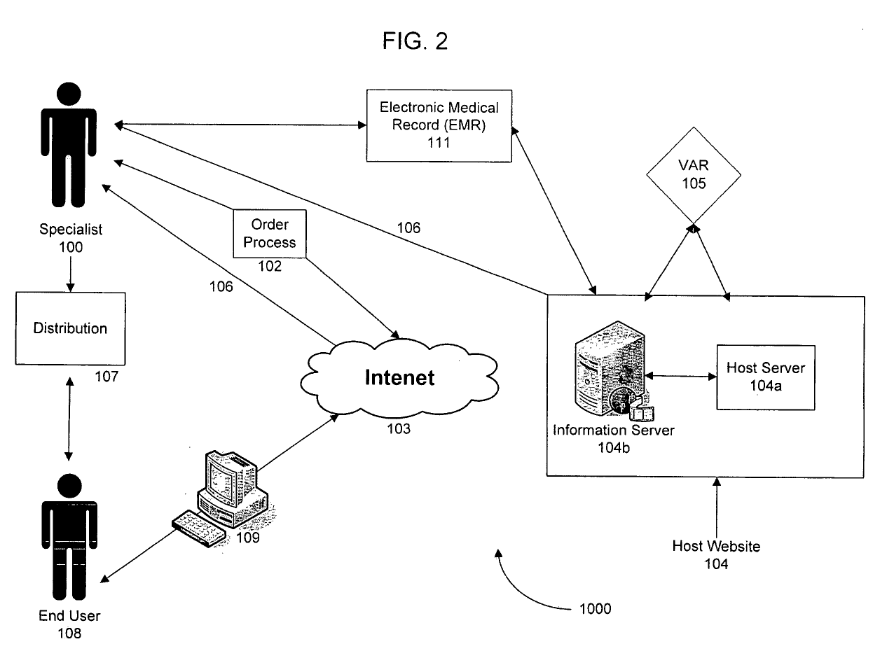

FIG. 2 illustrates an embodiment of a system 1000 for delivering information (a presentation) for an end user's education and/or for marketing purposes by the specialist or vendor. Such a communication system 1000 allows a specialist 100 to extend an end user's experience beyond an appointed consultation, such as a hospital visit, clinical visit, etc., by enabling end users 108 to receive information at home that relates to the end user's diagnoses and treatment. After a specialist 100 learns of a potential need of an end user 108, the specialist 100 may provide end user 108 access to a web-based presentation via the Internet or via a CD. Alternatively, such web-based presentation may be provided to the end user via a recordable media such as Audio Cassette, CD Recordable, Camcorder, DVD Recordable, Diskettes, minidisks, VHS etc. A recordable media, URL and/or a CD can contain a key having a unique ID that can unlock a web-based presentation specified by the specialist 100. The presentation can be customized to relate specifically to the needs of the end user 108 and can pertain to vendor 105 offerings as seen by the specialist 100. Further, to make an order of a product from the host website 104, various functionalities can be selected. System 1000 can be synchronized with an Electronic Record system 111. Within the Electronic Record system, the end user will be able to view the specialist's calendar in order to make an appointment or view follow-up appointments. The Electronic Record System 111 can also provide the specialist 100 with the ability to scan their database of patients, so as to determine which patient may receive information through the host website 104. Furthermore, the end users can view their history or profile, and then, interact with the specialist as it may relate to the end users' history or profile. As one example, an end user such as a patient can review his/her medical history, and observe that he/she was diagnosed with an ailment such as cataracts a few months ago. The medical history can contain information that relates to the severity of the diagnosed cataracts. The medical history can also contain information that relates to the number of end user (e.g., patient) visits to the specialist (e.g., doctor) concerning the diagnosed cataracts. The medical history will enable the patient to understand that the cataract is in a new stage of development. Within the Electronic Record System 111, the specialist can record treatment options, recommendations, etc. for the end user as they are suggested. Such specialist can also track the end user's treatment based on the chosen treatment option. Also, the Electronic Record system 111 provides the specialist 100 with the option to include an Informed Consent section with a field to enter a Customized Questionnaire. This may then be later accessed by a end user 108.

The presentation can be animated communication such as 3D animated communication. The communication can be delivered by streaming video. The provider of such 3D animated communication may be a host website and/or vendor. The 3D animations may be developed using, for example, 3D development tools (e.g., 3D Studio Max, Combusion and various 3D related plug-ins), or video editing software (e.g., Adobe After Effects), or hosted on a PHP/MySQL web server. Such web-based tools are used to present information to specialist 100 and to provide choices to the specialist as he/she dynamically interacts with the information. Of course, other programming languages may be employed. For example, ASP programming language could be used, instead of PHP, to write scripts that interact with a database associated with the present invention. The software tools are designed to facilitate a specialist's efficient interaction with a database, and to store and present information to the specialist via a graphical user interface (GUI). The database is used to store information and choices associated with specialists and end users. The core presentation software, which can be located on the host server 104a providing the host website 104, is configured to ensure that the host website 104 is operated through the use of a secure web browser, flash player, coded compact disks (CDs) and unique log-ins. As one example, the software is also configured to ensure that caching or local storage by end user 108 is prevented. All videos are capable of being encoded into flash video formats. In an embodiment, the host website 104 can be provided on the host server 104a which cooperates with an information server 104b. The host server 104a can be configured to control the handling of information via a host database, while the information server 104b can be configured to control access to presentations.

Network 103 may be any collection and arrangement of hardware and/or software allowing electronic communications between components in communication system 1000. For example, network 103 may be one or a collection of components associated with the public switched telephone network, local area networks, wide area networks, a global computer network such as the Internet, the World Wide Web, or any other suitable wireline or wireless communications technology.

Prior to disseminating the recordable media, CDs or URL, the specialist 100 can access the host website 104 to customize the presentation of educational and marketing recommendations. This customized presentation can reside on host server 104a associated with the host website 104 in order to create a unique profile for the specialist 100. By associating a presentation with a unique ID, the host website 104 is provided with a capability to protect the content disseminated to the specialist 100, track the content when it is played by the end user 108, and control the scope of release of the presentation. The specialist 100 may also supply the host website 104 with custom videos and images (i.e., customized content) to upload as well. Such customized content may be uploaded to the host server 104b, wherein such customized content may be unique to the specialist's 100 account and can be made available to the end user 108 in presentations accessed via the Internet or CDs.

In an embodiment, a vendor's 105 advertisement may appear before, between, after or next to the presentation when a end user 108 receives a recordable medium, CD or URL to access a presentation on a specific topic. As one example, a CD may be given to an end user 108 identifying a presentation on a subject relating to the application and removal of contact lenses. During and after the presentation is played, the end user 108 may see a display screen relating to companies that deal with contact lenses. An end user may click on the advertisement of any of such companies such that a webpage launches and a commercial advertisement or other presentation may then proceed to play. Such advertisement may include an “order now” button to enable the end user to order contact lenses from the company. By clicking an advertisement, the end user 108 may also have the opportunity to visit the vendor's 105 website for a direct purchase. This action may be tracked, and thus, enable the specialist 100 to receive recognition in the form of cash, points and/or co-op rewards. Alternatively, the end user may be redirected back to the specialist's website. A variety of fee arrangements may be negotiated between the host website 104 and the vendor 105. For example, the host website may charge a fee to the vendor 105 each time a end user clicks on a presentation associated with the vendor 105. A fee may also be charged to the vendor 105 each time the presentation is displayed. The host website 104 may provide feedback to the vendors 105 based on the number of presentations clicked and/or displayed.

In an embodiment, the specialist 100 passes a recordable medium, CD or URL along to one of his/her end users 108 via a distribution channel 107. Each CD or URL passed by the specialist 100 is unique to each respective end user. The presentation software may be operated by the host website 104. The specialist 100 may modify a presentation for the end user 108 via the host website, in order to create a more customized presentation that is tailored to the end user's treatment. This may be achieved by the specialist logging on to the host website 104 via the internet 103. After logging on, the specialist may begin to personalize the presentation to suite the needs of end user 108. The specialist may add or remove specific videos and vendor offerings depending on what is appropriate for the end user to view. More details with respect to the specialist's experience as he/she creates an account, manages an account and interacts with the presentation software are provided below with respect the CD and/or URL. It is understood to a person of ordinary skill that such methods can be correspondingly applied to a recordable medium as well.

Further, in an embodiment, for the end user 108, the experience begins when he/she receives the CD or URL from their specialist 100 via a distribution 107. The presentation begins after the end user 108 inserts the CD into his/her computer 109, or after accessing the URL received from the specialist 100. The CD/URL has specific encrypted information which matches the online presentation with its intended end user 108. Of course, the CD/URL can be configured with specific encrypted information that enables a end user 108 to link to one or more presentations. The host website 104 and/or specialist 100 may limit the number of times that a presentation can be viewed by an end user. As one example, a end user 108 may be limited to view a presentation 10 times. Thus, when the end user 108 receives a URL or a CD from the specialist 100 that is tailored to the end user 108, such a URL or CD is configured with a unique key containing encrypted information that matches an online presentation with the end user 108. When the end user loads the CD or clicks a provided URL link, an internet connection is detected and the unique key facilitates the URL link or CD to handshake with the host server 104. The handshake is configured to enable the host server 104 to identify the URL or CD to a specific specialist 100, and identify the specific presentation designed for the end user 108. During the detection process, a short video clip from the CD may be played. The end user 108 watches a presentation defined by the specialist 100.

End users may be identified when they watch the presentation online. This helps the end user have a more tailored/customized experience. Further, the end users can be tracked to ensure that they watch the intended presentation. All usage and playback may be captured and measured for statistical purposes. A basic report may be provided to the specialist 100 or the vendor 105, and the host website 104 may maintain a highly detailed report for improving its operations. The viewing habits or behaviors of the end users may also serve as data to the host website's administrators for future advertising.

The presentation may be interactive. There can be “call-to-action” and learning activities associated with the presentation software to ensure that the end user is engaged in the learning process and acts on information that is disseminated from the host website. The host website 104 may permit a vendor 105 to offer the end user 108 specific recommendations based on the specialist's 100 treatment plan, and/or the end user's profile information. At the end of the operation of the presentation software, a greeting in the form of a thank-you note may be flashed across the display screen.

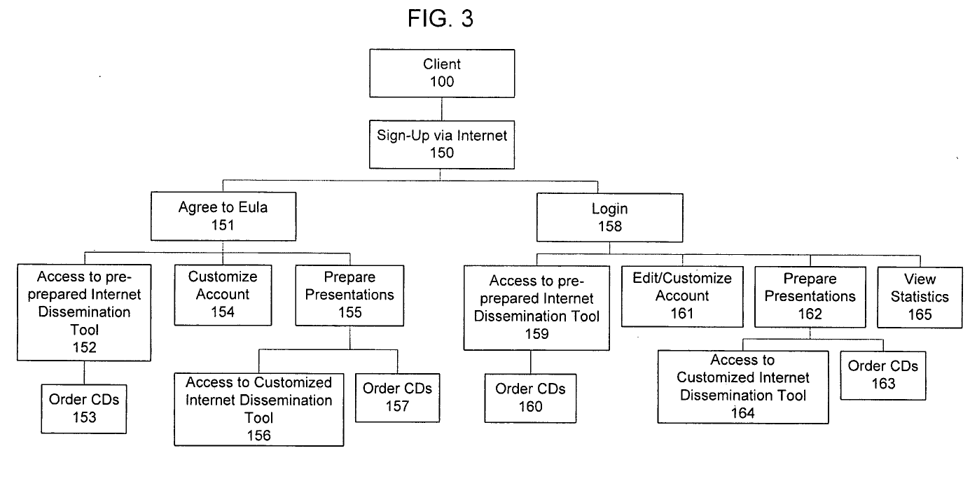

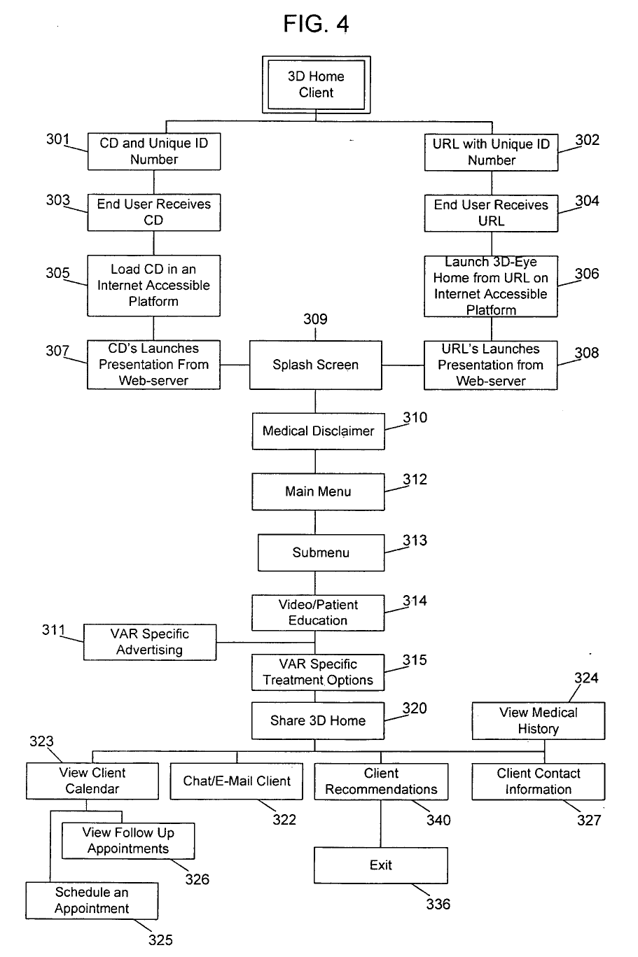

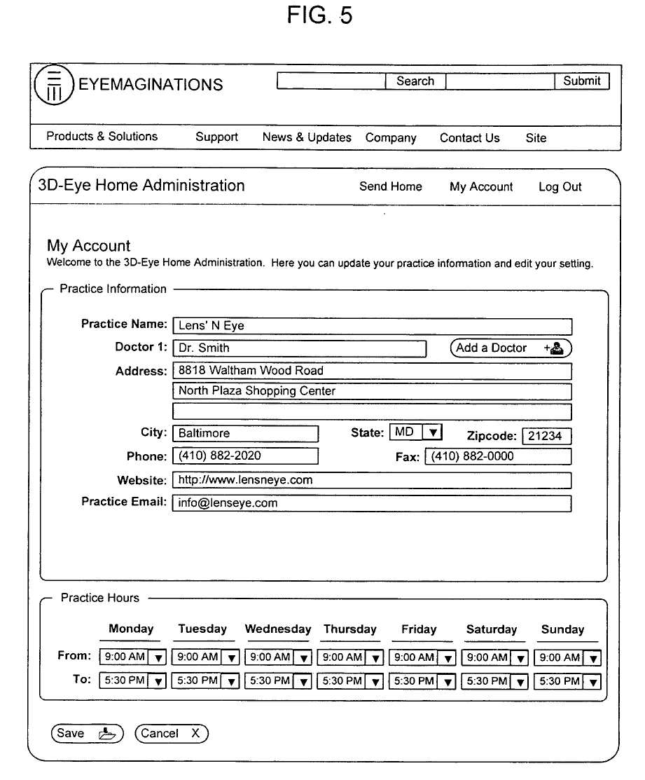

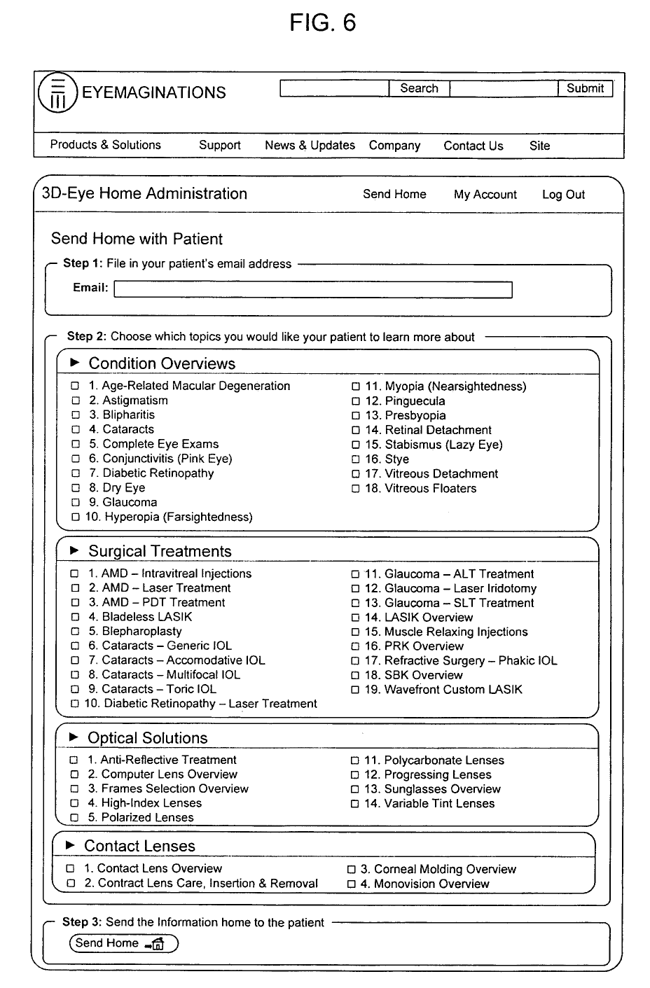

FIG. 3 illustrates in flow-chart form the method employed by a host website client such as a specialist in creating an account, managing the account, preparing a presentation, disseminating and/or ordering a presentation. The flow chart 2000 illustrates the experience of a host website client 100 (e.g., a specialist), as he/she creates an account, manages the created account, uses the internet dissemination tool, prepares presentations and orders products from the host website. In operation 150, the specialist 100 begins the ordering process of a host website product via an internet accessible platform. By using an internet accessible platform, the specialist 100 is able to gain access to the appropriate URL, which then enables the client to adequately connect to the host website via the internet. If the specialist is creating a new account, the specialist may initially be requested to create an Account with a username and password. Such username and password may be stored within a storage medium located within the host website 104. The client/specialist 100 may then fill in their account information, in operation 154 after the specialist 100 has agreed to an end user license agreement, in operation 151. FIG. 5 illustrates an exemplary interface for the specialist to customize their account. Such account information may include the specialist's settings and preferences and contact information. The settings and preferences are configured to provide the requirements for the specialist 100 to interact with the technology, while the contact information may affect how the end user views the content. The contact information may include practice name, the specialist's name, phone number, fax number and/or desired URL address and may be displayed within the product. The specialist has the ability to use a pre-prepared internet dissemination tool 152. This tool allows the specialist to disseminate pre-prepared content to the end user by simply obtaining the end-user's email address, selecting the content he/she wishes to disseminate, and activating a “send home” button. In operation 153, the specialist may also order CDs of the pre-prepared content to give out to the end-user. The specialist can also prepare a customized presentation to send to the end user, in operation 155. FIG. 6 illustrates an exemplary interface for the specialist to send an e-mail via the Internet relating to educational and marketing recommendations via the Internet. Here, the specialist can modify pre-prepared presentations by including or excluding certain content or create his/her own content. If the specialist decides to create his/her own content, a custom user interface allows the specialist to upload his/her own content to the host server 104a which can then be streamed via the Internet through the host server to the end user. In operation 156, such customized or unique presentation may be made available to the end user via the Internet dissemination tool. Alternatively, the specialist can order CD's, in operation 157. The specialist's customized presentation may be stored within the host server 104a in a location designated to specialist by activating, for example, a “Save and Continue” button. The host website may provide various functionalities and/or options that may be selected by the specialist 100 in order to make an order of products from the host website. As one example, the host website 104 may provide a functionality that enables the specialist 100 to synchronize with an Electronic Record system 111. Within the Electronic Record system, the specialist may be able to synchronize and disseminate unique presentations specific to an end user. In addition, an end user 108 may be able to view the specialist's calendar (as shown in operation 323 of FIG. 4) in order to make an appointment or view follow-up appointments. Further, within the Electronic Record system synchronization, the specialist may select an option to include an Informed Consent section with a field to enter a customized questionnaire. Further, the end user may be able to view his/her History (operation 324 of FIG. 4), wherein such history relates to the medical relationship between the end user 108 and the specialist 100. As noted above, the specialist 100 can scan his/her medical records database to identify end users 108 to whom the specialist 100 can send presentations. Also, the end users 108 can track their medical history to identify changes, for example, and review previously suggested treatment options, recommendations, etc. The specialist 100 may opt for a Chat/E-mail functionality (operation 322 of FIG. 4) to help facilitate communication with the end user 108.

If the specialist is a returning user, he/she may login to their administrative system in order to access the account, in operation 158. Similar to the new account, the specialist may use the pre-prepared internet dissemination tool, in operation 159; order CDs, in operation 160; edit/customize their account, in operation 161; prepare new presentations, in operation 162; order CDs for new presentations, in operation 163; access an Internet dissemination tool so as to make new presentations available via the internet dissemination tool, in operation 164; and/or view statistics, in operation 165. The specialist or vendor may view statistics relating to his/her account by clicking on, for example, a view stats link, in operation 165. This interface may contain at least two categories of information: (1) the client (i.e., specialist) order information; and (2) the end user behavioral and demographic information. With respect to the specialist's order information, the specialist 100 may determine the number of orders he/she has placed regarding any of the following: a particular presentation, CDs or URL presentations that were ordered, views per presentation that are permitted, and/or the total number of available views there are within the orders. In addition, there may be a recorded log of the number of views used in comparison to the total available views. This section may also include the total number of unique users that may have viewed the specific presentation. Further, the view stats page may contain a section designated for user sessions within which the client or vendor may be able to view the unique users that have watched the presentations, and the date and number of views or clicks the client or vendor has accumulated. Further, there is a view activity link that is specific to each end user that enables a specialist to view the number of times the client viewed the presentation. The host website is capable of tracking every input or mouse event, and the date, time, pattern and IP address of every end user.

Within the presentations that have been customized for the specialist 100 (operations 155, 162), the specialist 100 may place another order. When the specialist 100 selects the order link (operations 157, 163), he/she will then either receive presentation specific CDs via mail or be given access to the Internet dissemination tool (operation 156, 164) via the Internet.

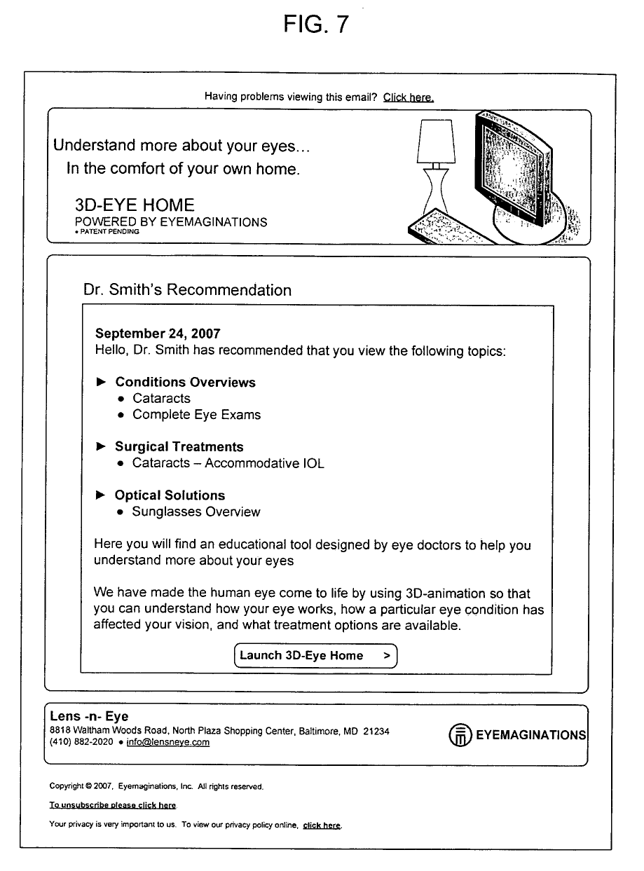

FIG. 4 illustrates in flow-chart form the process by which an end user 108 communicates with the host 104 via an Internet platform 109 in order to receive treatment information unique to the end user. In an embodiment, the specialist 100 passes a presentation CD or presentation URL along to their end users via a distribution channel 107, in operation 301. For an end user 108, the experience begins when a unique ID on a CD (operation 301) or in a URL (operation 302) is associated with such an end user. The end user then receives such a CD in operation 303 or URL in operation 304 from their specialist 100. The presentation begins after the end user inserts the CD into his/her computer (operation 305), or after accessing the received URL (operation 306). This causes an interface to be launched in response to loading the CD (operation 307) or launching the URL (operation 308). The unique CD or unique URL handshakes with the host server, and identifies the CD or URL to the specific specialist and to the specific presentation designed for the end user. Thereafter, in operation 309, the presentation software may be launched for presentation to the end user 108. Such an end user can then view an interface that displays the specialist's educational and marketing recommendations, as illustrated in FIG. 7.

As represented in operations 301 and 302, the CD/URL has specific encrypted information which matches the online presentation with its intended end user 108. The end user 108 watches a presentation defined by the specialist 100. End users would be identified when they watch the presentation. This helps the end user have a more tailored/customized experience. Further, the end users are tracked to ensure that they watch the intended presentation. All usage and playback may be captured and measured for statistical purposes. A basic report may be provided to the specialist 100, and the host website 104 may maintain a highly detailed report for improving its operations. The viewing habits or behaviors of the end users may also serve as data to the host website's administrators for future advertising.

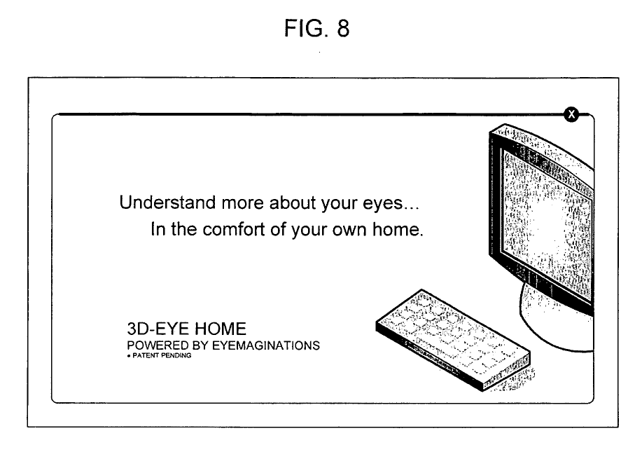

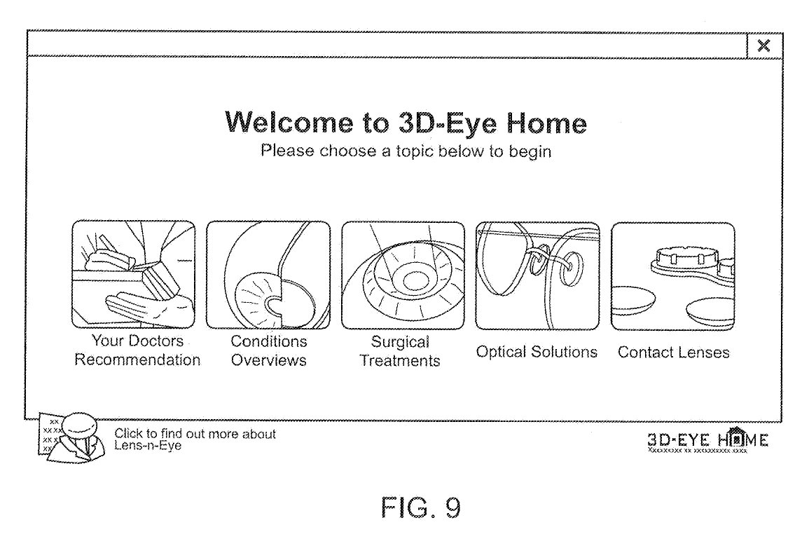

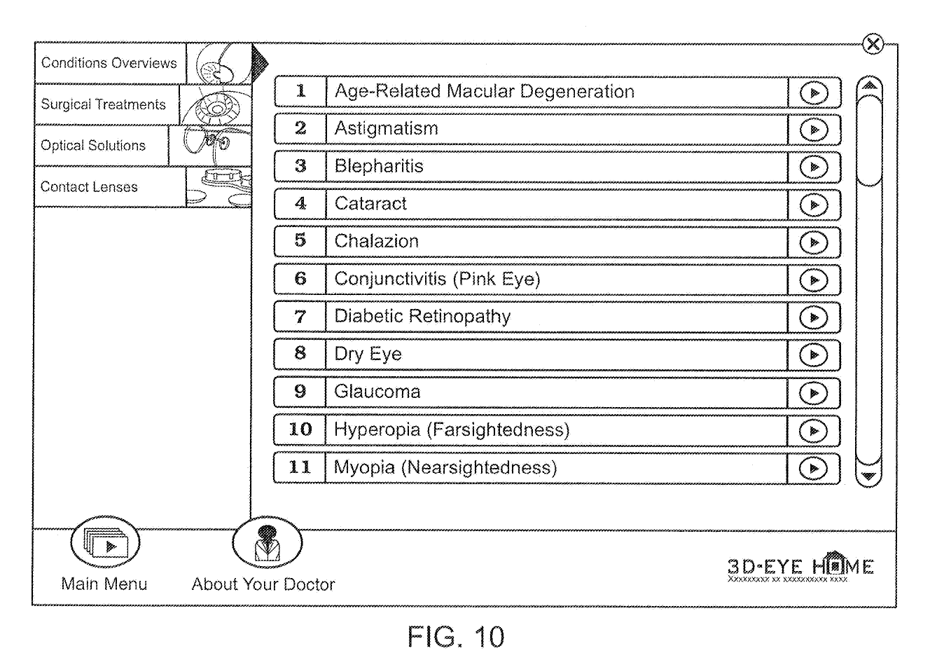

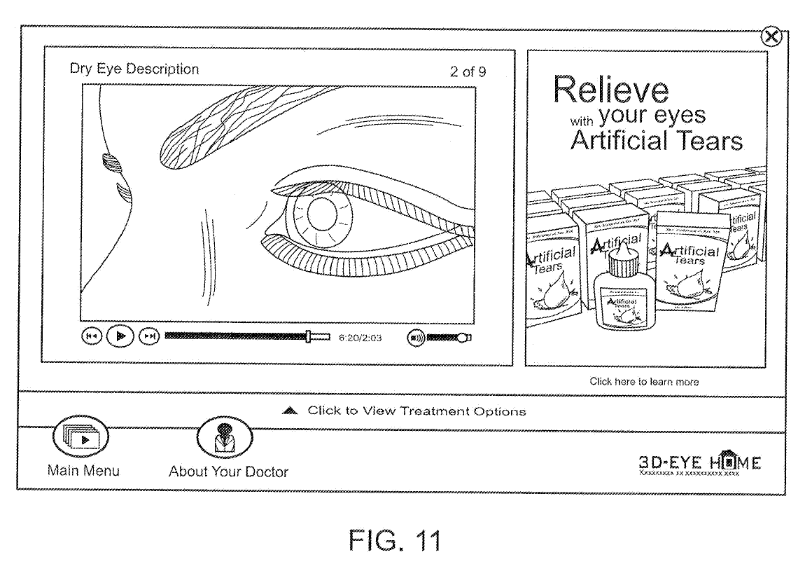

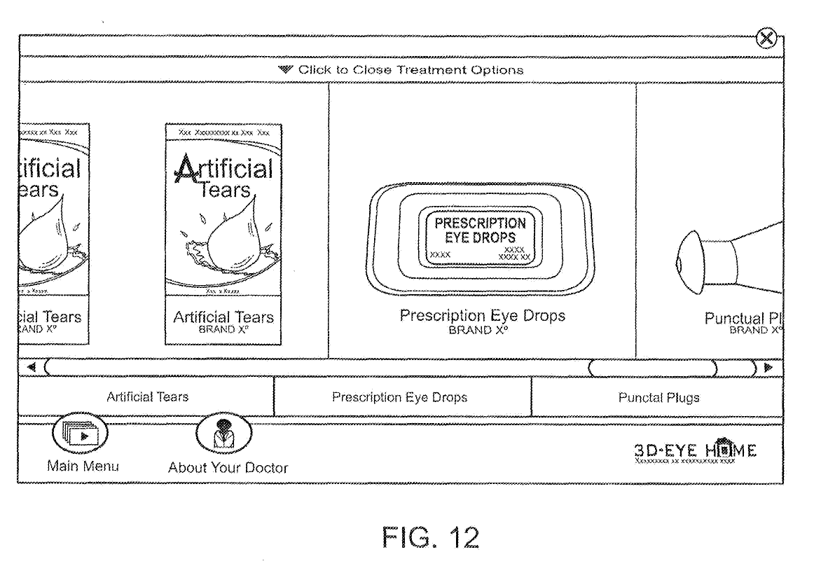

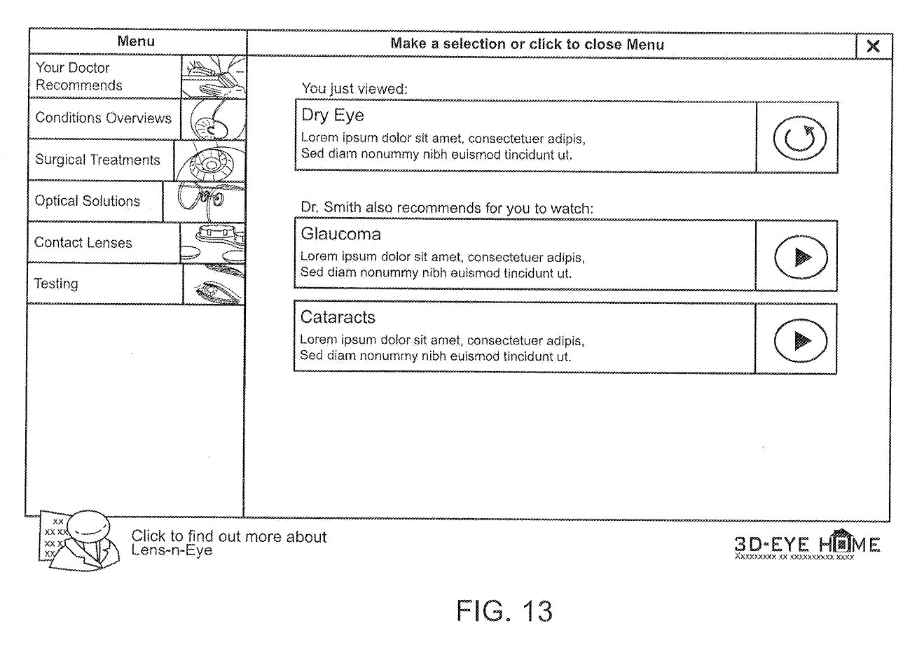

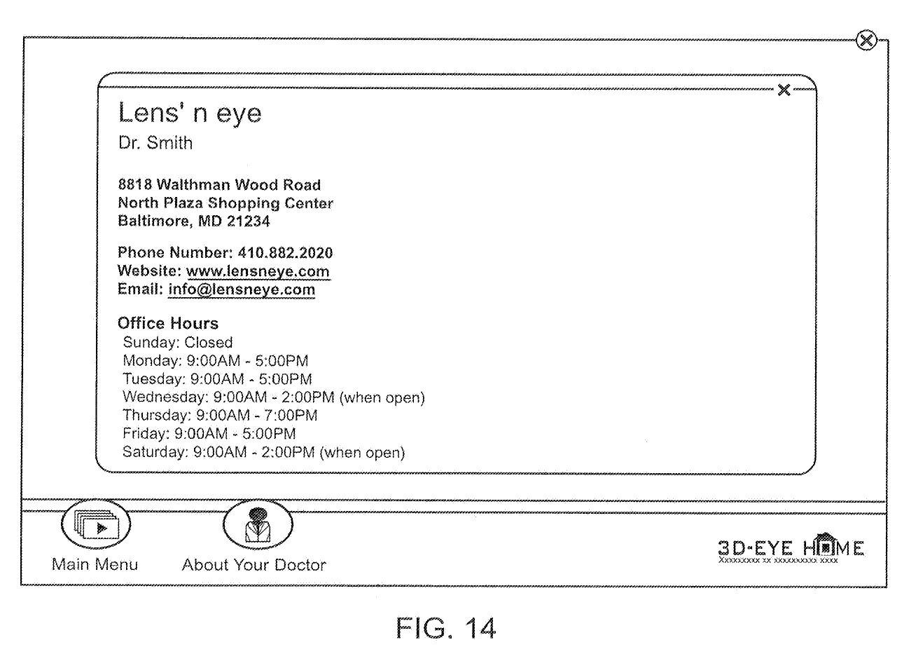

In operation 310, the end user is provided with an interface that may display disclaimer information provided by the specialist. When the end user agrees, such an end user may be provided with the main menu page of the specialist's recommendation, in operation 312. FIG. 9 illustrates an exemplary screenshot of a menu containing the specialist's recommendation. The end user may be permitted access any of the specialist's recommendation provided in the main menu page. If permitted to access a recommendation, the end user can be then link to a submenu of topics, which may be geared to provide the end user with more detailed information, in operation 313. FIG. 10 illustrates a submenu of topics. By selecting a topic in the submenu, the end user may view a video presentation relating to the selected topic, in operation 314. In operation 311, the host website may permit a vendor to offer the end user specific recommendations based on the specialist's treatment plan, and/or the end user's profile information. Such recommendations may appear throughout the presentation where appropriate. FIG. 8 illustrates an exemplary introductory interface that may be seen by an end user as the presentation is pulled from the host web server 104a. The presentation may be interactive. There are “call-to-action” and learning activities associated with the presentation software to ensure that the end user is engaged in the learning process and acts on information that is disseminated from the host website. FIG. 11 illustrates an exemplary screenshot of the recommended education (presentation) and vendor offering made to the end user. The end user can access specific treatment options recommended by the specialist, in operation 315. Such recommendation can relate to a vendor's offerings. FIG. 12 is an exemplary screenshot of a narrowed selection of vendor offerings specific to the end user's case. After the presentation has played all of the way through, the end user is presented with a summary screen and a prompt to continue with the remaining recommendations from the specialist, as illustrated in FIG. 13. FIG. 14 illustrates an exemplary screen-shot interface of the specialist's contact information and provides a platform for communication between the end user and the specialist. Also, a screen may prompt the end user to fill out a mandatory informed consent questionnaire.

In operation 320, the end user and the specialist are provided with tools to interact with one another. Therefore, at any point, the end user may choose from a menu of options as to whether to replay the presentation; review the vendor specific recommendations that are given throughout the presentation such as vendor specific products and/or services; review the specialist's contact information; view information about their specialist; communicate electronically with the specialist using the Chat/E-mail option (operation 322); view the specialist's calendar (operation 323) in order to schedule an appointment (operation 325) and/or view any already scheduled appointments (operation 326); and/or view the end user's Medical History (operation 324). Under the specialist's recommendations (operation 340), there will be a summary of all the vendor specific recommendations given throughout the presentation such as vendor specific products or services. Within specialist's contact information (operation 327), the end user may be able to view contact information for their specialist. FIG. 14 illustrates such an exemplary interface that provides an end user with the option to view his specialist's (e.g., “Dr. Smith”) contact information.

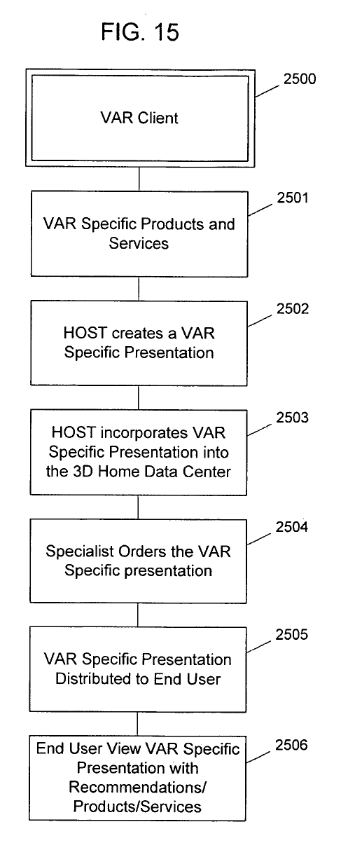

FIG. 15 illustrates in flow-chart form the vendor interaction and experience with the host website, specialist and the end user. The host website 104 will create Value Added Relationships (VAR) in operation 2500 with regards to the presentation products. The vendor may approach the host website administrators with products and services that they desire to incorporate into a VAR specific presentation (operation 2501). The host website may then create a custom presentation to highlight VAR specific products and services (operation 2502). The vendor may have the capability to autonomously update and/or maintain their products and services directly via the host website, without manual intervention at the host website. Next, the host website 104 may incorporate this presentation into the host server 104a (operation 2503) which may make it available for ordering by a specialist. Upon ordering (operation 2504), the specialist may order the VAR specific presentation and distribute it to the end user (operation 2505). As the end user views the VAR specific presentation, the Vendor's products and services will be highlighted throughout the presentation (operation 2506). There may also be provided a summary of the recommended products and services within the presentation for the end user.

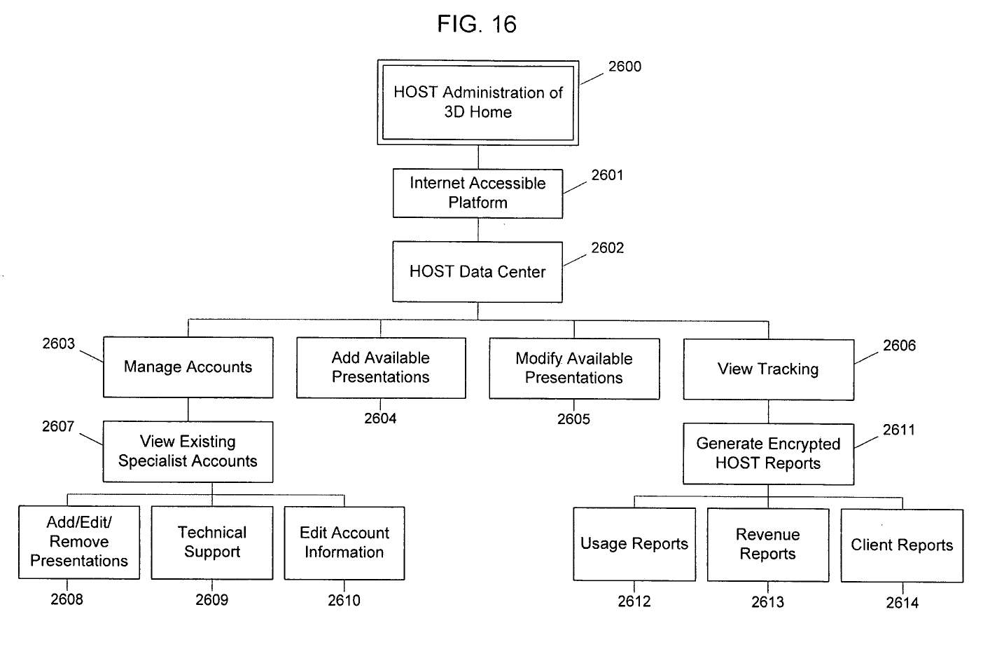

FIG. 16 illustrates in flow-chart form the host website's administration of the presentation software. The host website may be able to manage all of the functionalities of the presentation software though an Administration System (operation 2600). A host website administrator may login to the host server 104a (operation 2602) via an internet accessible platform (operation 2601). The host website administrator may be able to manage all accounts associated with specialists (operation 2603). Managing these accounts includes may include viewing the accounts (operation 2607), editing account information (operation 2610), providing technical support (operation 2609), and/or adding/editing/removing presentations (operation 2608) from the host server. In addition, the host website may have the ability to make new presentations available for purchase (operation 2604), modify existing presentations for purchase (operation 2605), and/or view tracking with regards to the usage of presentation (operation 2606). These tracking reports may be encrypted to ensure HIPAA compliance (operation 2611). Some examples of these tracking reports may be Usage Reports (operation 2612), Revenue Reports (operation 2600) and the specialist's ordering reports.

Although the present invention has been described in connection with the illustrated embodiments, it will be appreciated and understood that modifications may be made without departing from the spirit and scope of the invention.

What is claimed is:

1. A method of providing at least one presentation via a network, comprising:
associating an ID with at least one presentation;
producing a product containing the ID;
providing the product to an end user; and
permitting the end user to access a host computer in order to view the at least one presentation when the end user connects to the host computer via the network in response to the ID in the product.

2. The method of claim 1, further comprising:
permitting the end user to view a schedule associated with a specialist so that the end user can schedule an appointment and/or view follow-up appointments with the specialist; and
permitting the end user to view his/her profile or history so that the end user can interact with the specialist based on the viewed profile or history of the end user.

3. The method of claim 1, wherein the product comprises a compact disk, recordable media and/or URL.

4. The method of claim 1, further comprising:
displaying advertisements associated with a vendor in proximity to the at least one presentation.

5. The method of claim 4, further comprising:
providing feedback to the vendor based on a number of advertisements clicked by the end user and/or displayed to the end user.

6. The method of claim 4, further comprising:
permitting the vendor to directly update and/or maintain the displayed advertisements.

7. The method of claim 1, further comprising:
tracking the viewing of the at least one presentation by the permitted end user.

8. The method of claim 1, wherein the ID is associated with multiple presentations.

9. The method of claim 1, further comprising:
limiting a number of times the end user can view the at least one presentation.

10. A system for providing at least one presentation, comprising:
a network to connect a plurality of computers; and
at least one host computer connected to the network to:
associate an ID with at least one presentation,
encode a product with the ID,
transmit the product to an end user, and
permit the end user to access the at least one host computer in order to view the at least one presentation when the end user connects to the host computer via the network in response to the ID in the product.

11. The system of claim 10, wherein the at least one host computer to also:
permit the end user to display a schedule associated with a specialist so that the end user can schedule an appointment and/or view follow-up appointments with the specialist; and
permit the end user to view his/her profile or history so that the end user can interact with the specialist based on the viewed profile or history of the end user.

12. The system of claim 10, wherein the product comprises a compact disk, recordable media and/or URL.

13. The system of claim 10, wherein:
the at least one host computer to display advertisements associated with a vendor associated with the end user viewing the at least one presentation.

14. The system of claim 13, wherein:
the at least one host computer to also provide feedback to the vendor based on a number of advertisements clicked by the end user and/or displayed to the end user.

15. The system of claim 13, wherein:
the at least one host computer to permit the vendor to directly update and/or maintain the displayed advertisements.

16. The system of claim 10, wherein:
the at least one host computer to also track the viewing of the at least one presentation by the permitted end user.

17. The system of claim 10, wherein the ID is associated with multiple presentations.

18. The system of claim 10, wherein:
the at least one host computer to also limit a number of times the end user can view the at least one presentation.

19. A method of providing at least one presentation via a network, comprising:
receiving first information associated with an end user; and
providing a product to the end user based on the first information, the product configured to comprise second information so that the end user can access at least one presentation via the network based on the second information.

20. The method of claim 19, wherein the first information comprises a medical condition associated with the end user.

21. The method of claim 19, wherein the second information comprises a ID associated with the product.

22. A system for providing at least one presentation, comprising:
a network to connect a plurality of computers; and
at least one computer connected to the network to:
receive first information associated with an end user, and
provide a product to the end user based on the first information, the product configured to comprise second information so that the end user can access at least one presentation via the network based on the second information.

23. The method of claim 22, wherein the first information comprises a medical condition associated with the end user.

24. The method of claim 22, wherein the second information comprises a ID associated with the product.

25. A system for providing at least one presentation, comprising:
a network;
at least one computer and connected to the network to:
order a product, the product configured to comprise information;
at least one host computer to:
associate the information with at least one presentation, and
permit the end user to access the at least one host computer in order to view the at least one presentation when the end user connects to the at least one host computer via the network in response to the information;
at least one computer associated with the end user to:
receive the product after the product is configured to comprise the information, and
access the at least one host computer based on the information; and
an output device to display the at least one presentation to the end user after access to the host computer is granted.
